(19) United States
(12) Patent Application Publication
(10) Pub. No.: US 2008/0146129 A1
(43) Pub. Date: Jun. 19, 2008

(54) Fast break-in polishing pad and a method of making the same

(76) Inventors: Makoto Kouzuma, Phoenix, AZ (US); Scott B. Daskiewich, Oriskany, NY (US); Peter Renteln, San Ramon, CA (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/953,746

(22) Filed: Dec. 10, 2007

Related U.S. Application Data
(60) Provisional application No. 60/869,214, filed on Dec. 8, 2006.

(51) Int. Cl. B24D 11/00; B29C 67/20; B29C 35/08

(52) U.S. Cl. 451/527; 264/41; 264/400

(57) ABSTRACT

The present invention is directed to a fast break-in polishing pad, which chemically and/or physically allows for a high rate of absorption of water and/or chemical slurry by decreasing the maximum absorption distance into the pad. In a preferred embodiment, this decrease in distance is achieved by forming a plurality of holes in the pad. In a preferred embodiment, the distance between the hole edges is no greater than twice the pad thickness. In other exemplary embodiments, the maximum distance can be decreased by applying a chemical foaming agent to the open-air mix while in the liquid phase. In another exemplary embodiment, the maximum distance can be decreased by including the addition of a cell-opening surfactant applied to the open-air mix while in the liquid phase. In another exemplary embodiment, the maximum distance can be decreased by directly injecting microbubbles into the open-air mix while in the liquid phase.

### CROSS-REFERENCE TO RELATED APPLICATIONS

This application claims priority to U.S. Provisional Patent Application Ser. No. 60/869,214, entitled “Fast Break-In Polishing Pad and Method of Making Same,” filed Dec. 8, 2006.

### FIELD OF INVENTION

The present invention is generally related to a fast break-in polishing pad, which chemically and/or physically allows for an increased rate of absorption of water and/or chemical slurry into the pad.

### BACKGROUND OF THE INVENTION

Typical methods of manufacturing silicon semiconductor substrate wafers, for use in subsequent semiconductor device fabrication, include sawing a single crystal silicon ingot into multiple slices, forming beveled, peripheral edges on each slice to reduce the risk of cracking or breakage of the slice, lapping each beveled slice to remove saw marks and surface defects from the front and back side of each slice, thinning the slice to relieve stress accumulated from the sawing process and improve flatness, etching the surface of each slice to remove mechanical damage, polishing at least one surface of each slice to a mirror finish and final flatness, and cleaning the resulting polished wafers to remove polishing agent and foreign substances attached thereon.

Conventionally, the process of polishing silicon semiconductor substrate wafers to improve flatness is accomplished by a mechanochemical process in which one or more polishing pads, typically made of urethane, is used with an alkaline polishing solution (slurry), commonly comprising fine abrasive particles such as silica or cerium. The silicon wafer is supported between a platen covered with a polishing pad and a carrier to which the wafer is attached, or, in the case of double-sided polishing, the wafer is held between two platens, each covered with a polishing pad. The pads are typically about 1 mm thick and pressure is applied to the wafer surface. The wafer is mechanochemically polished by relative movement between the platen and the wafer.

During polishing, pressure is applied to the wafer surfaces by pressing the pad and the wafer together in a polishing tool, whereby a uniform pressure is generated over the entire surface owing to the compressive deformation of pads. Polishing tools often have dynamic heads which can be rotated at different rates and at varying axes of rotation. This removes material and evens out any irregular topography, making the wafer flat or planar.

Currently, new polishing pads do not result in sufficiently flat wafers immediately after installing the pads on the polishing tool. Instead, the polishing pads are typically “broken-in” after first affixing them to the platens of a polishing tool. A typical break-in process often includes diamond dressing the pads and/or running “dummy” wafers in order to improve the stability of the polishing pad performance. Dummy wafers are often processed under the same conditions which polishing of actual production wafers takes place. This ensures that subsequent polished wafers are acceptably flat and uniform.

One problem with the current break-in process is the length of tool time needed to break-in the pad. Logically, the longer a pad takes to break in, the less tool time is spent in actual production of commercial wafer product. A longer break in time also requires the use of more dummy wafers. Both the time spent on the tool and the additional dummy wafers increase the cost associated with polishing pads. As such, it is desirable to reduce the break-in time for a pad.

### SUMMARY OF THE INVENTION

The present invention is directed to a fast break-in polishing pad, which chemically and/or physically allows for a high rate of absorption of water and/or chemical slurry by decreasing the maximum diffusion distance into the pad. In one exemplary embodiment, this decrease in distance is achieved by forming a plurality of holes in the pad configured to optimize the rate of absorption and to reduce break-in time of said foamed polishing pad. In another exemplary embodiment, the distance between the hole edges is no greater than twice the pad thickness apart.

With regards to processing of the fast break-in polishing pad configured to optimize the rate of absorption and to reduce the break-in time, in another exemplary embodiment, the maximum diffusion distance can be decreased by applying at least one of a chemical foaming agent, wherein said chemical foaming agent allows for formation of a plurality of small pores in the foam, and a cell opener, wherein said cell opener allows for formation of a plurality of small cells in the foam, to a prepolymer solution. In another exemplary embodiment, the maximum distance can be decreased by directly injecting gas bubbles into an open-air mix.

### BRIEF DESCRIPTION OF THE DRAWINGS

The subject matter of the present invention is particularly pointed out and distinctly claimed in the concluding portion of the specification. A more complete understanding of the present invention, however, can be obtained by referring to the detailed description and claims when considered in connection with the drawing figures, wherein like numerals denote like elements, and wherein:

FIG. 1 illustrates a fast break-in polishing pad with holes in accordance with one exemplary embodiment of the present invention;

FIG. 2 illustrates a fast break-in polishing pad with holes and lateral diffusion of water and/or slurry in accordance with one exemplary embodiment of the present invention;

FIG. 3 illustrates a cut-away of a fast break-in polishing pad with holes in accordance with one exemplary embodiment of the present invention;

FIG. 4a illustrates a fast break-in polishing pad with grooves in accordance with one exemplary embodiment of the present invention;

FIG. 5a illustrates an exemplary unit cell containing a spherical cell in accordance with one exemplary embodiment of the present invention; and

FIG. 5b illustrates an exemplary unit cell containing eight spherical cells in accordance with one exemplary embodiment of the present invention.

### DETAILED DESCRIPTION

In accordance with an exemplary embodiment of the present invention, a polishing pad is disclosed for use in polishing silicon semiconductor substrate wafers and glass. In this exemplary embodiment, the polishing pad is chemically and/or physically configured to have an increased rate of absorption of water and/or chemical slurry into the pad. Stated another way, the pad can be configured to become saturated with water and/or chemical slurry faster, facilitating a faster break-in relative to pads that are not so configured.

### Polishing Pads

In accordance with the present invention, commercially available polishing pads are commonly made of polymer foam—commonly polyurethane, polyethylene, polystyrene, polyvinyl chloride, acryl foam or a mixture thereof. These polymer foams can be produced by mixing a polymerizing agent, typically an isocyanate-terminated monomer, and a prepolymer, typically an isocyanate functional polyol or a polyol-diol mixture.

Classes of polymerizing agents, isocyanate-terminated monomers, that may be used to prepare the particulate crosslinked polyurethane include, but are not limited to, aliphatic polyisocyanates; ethylenically unsaturated polyisocyanates; alicyclic polyisocyanates; aromatic polyisocyanates wherein the isocyanate groups are not bonded directly to the aromatic ring, e.g., xylene diisocyanate; aromatic polyisocyanates wherein the isocyanate groups are bonded directly to the aromatic ring, e.g., benzene diisocyanate; halogenated, alkylated, alkoxylated, nitrated, carbodiimide modified, urea modified and biuret modified derivatives of polyisocyanates belonging to these classes; and dimerized and trimerized products of polyisocyanates belonging to these classes.

Examples of aliphatic polyisocyanates from which the isocyanate functional reactant may be selected include, but are not limited to, ethylene diisocyanate, trimethylene diisocyanate, tetramethylene diisocyanate, hexamethylene diisocyanate (HDI), octamethylene diisocyanate, nonamethylene diisocyanate, dimethylpentane diisocyanate, trimethylhexane diisocyanate, decamethylene diisocyanate, trimethylhexamethylene diisocyanate, undecanetriisocyanate, hexamethylene triisocyanate, diisocyanato-(isocyanatomethyl)octane, trimethyl-diisocyanato (isocyanatomethyl)octane, bis(isocyanatoethyl) carbonate, bis(isocyanatoethyl)ether, isocyanatopropyl-diisocyanatohexanoate, lysinediisocyanate methyl ester and lysinetriisocyanate methyl ester.

Examples of ethylenically unsaturated polyisocyanates from which the isocyanate functional reactant may be selected include, but are not limited to, butene diisocyanate and butadiene diisocyanate. Alicyclic polyisocyanates from which the isocyanate functional reactant may be selected include, but are not limited to, isophorone diisocyanate (IPDI), cyclohexane diisocyanate, methylcyclohexane diisocyanate, bis(isocyanatomethyl) cyclohexane, bis(isocyanatocyclohexyl) methane, bis(isocyanatocyclohexyl) propane, bis(isocyanatocyclohexyl) ethane, and isocyanatomethyl-(isocyanatopropyl)-isocyanatomethyl bicycloheptane.

Examples of aromatic polyisocyanates wherein the isocyanate groups are not bonded directly to the aromatic ring from which the isocyanate functional reactant may be selected include, but are not limited to, bis(isocyanatoethyl) benzene, tetramethylxylene diisocyanate, bis(isocyanato-methylethyl) benzene, bis(isocyanatobutyl) benzene, bis(isocyanatomethyl) naphthalene, bis(isocyanatomethyl)diphenyl ether, bis(isocyanatoethyl)phthalate, mesitylene triisocyanate and di(isocyanatomethyl) furan. Aromatic polyisocyanates, having isocyanate groups bonded directly to the aromatic ring, from which the isocyanate functional reactant may be selected include, but are not limited to, phenylene diisocyanate, ethylphenylene diisocyanate, isopropylphenylene diisocyanate, dimethylphenylene diisocyanate, diethylphenylene diisocyanate, diisopropylphenylene diisocyanate, trimethylbenzene triisocyanate, benzene triisocyanate, naphthalene diisocyanate, methylnaphthalene diisocyanate, biphenyl diisocyanate, ortho-tolidine diisocyanate, diphenylmethane diisocyanate, bis(methyl-isocyanatophenyl) methane, bis(isocyanatophenyl) ethylene, dimethoxy-bipheny-diisocyanate, triphenylmethane triisocyanate, polymeric diphenylmethane diisocyanate, naphthalene triisocyanate, diphenylmethane-triisocyanate, methyldiphenylmethane pentaisocyanate, diphenylether diisocyanate, bis(isocyanatophenylether) ethyleneglycol, bis(isocyanatophenylether) propyleneglycol, benzophenone diisocyanate, carbazole diisocyanate, ethylcarbazole diisocyanate and dichlorocarbazole diisocyanate.

Examples of polyisocyanate monomers having two isocyanate groups include, xylene diisocyanate, tetramethylxylene diisocyanate, isophorone diisocyanate, bis(isocyanatocyclohexyl)methane, toluene diisocyanate (TDI), diphenylmethane diisocyanate (MDI), and mixtures thereof.

Commonly used prepolymers, isocyanate functional polyols, include, but not limited to, polyether polyols, polycarbonate polyols, polyester polyols and polycaprolactone polyols. Commercial prepolymers, such as Adiprene® L315 a TDI, terminated polyether based (PTMEG), are readily available.

Further, the molecular weight of the prepolymers can vary widely, for example, having a number average molecular (Mn) of from 500 to 15,000, or from 500 to 5000, as determined by gel permeation chromatography (GPC) using polystyrene standards.

Classes of polyols that may be used to prepare the isocyanate functional prepolymers of the first component of the two-component composition used to prepare the particulate crosslinked polyurethane include, but are not limited to: straight or branched chain alkane polyols, e.g., ethanediol, propanediol, propanediol, butanediol, butanediol, glycerol, neopentyl glycol, trimethylolethane, trimethylolpropane, di-trimethylolpropane, erythritol, pentaerythritol and di-pentaerythritol; polyalkylene glycols, e.g., di-, tri- and tetraethylene glycol, and di-, tri- and tetrapropylene glycol; cyclic alkane polyols, e.g., cyclopentanediol, cyclohexanediol, cyclohexanetriol, cyclohexanedimethanol, hydroxypropylcyclohexanol and cyclohexanediethanol; aromatic polyols, e.g., dihydroxybenzene, benzenetriol, hydroxybenzyl alcohol and dihydroxytoluene; bisphenols, e.g., isopropylidenediphenol; oxybisphenol, dihydroxybenzophenone, thiobisphenol, phenolphthlalein, bis(hydroxyphenyl)methane, (ethenediyl)bisphenol and sulfonylbisphenol; halogenated bisphenols, e.g., isopropylidenebis(dibromophenol), isopropylidenebis(dichlorophenol) and isopropylidenebis(tetrachlorophenol); alkoxylated bisphenols, e.g., alkoxylated isopropylidenediphenol having from 1 to 70 alkoxy groups, for example, ethoxy, propoxy, and butoxy groups; and biscyclohexanols, which can be prepared by hydrogenating the corresponding bisphenols, e.g., isopropylidene-biscyclohexanol, oxybiscyclohexanol, thiobiscyclohexanol and bis(hydroxycyclohexanol)methane. Additional classes of polyols that may be used to prepare isocyanate functional polyurethane prepolymers, include for example, higher polyalkylene glycols, such as polyethylene glycols having number average molecular weights (Mn) of, for example, from 200 to 2000; and hydroxy functional polyesters, such as those formed from the reaction of diols, such as butane diol, and diacids or diesters, e.g., adipic acid or diethyl adipate, and having an Mn of, for example, from 200 to 2000. In an embodiment of the present invention, the isocyanate functional polyurethane prepolymer is prepared from a diisocyanate, e.g., toluene diisocyanate, and a polyalkylene glycol, e.g., poly(tetrahydrofuran).

Additionally, the isocyanate functional polyurethane prepolymer may optionally be prepared in the presence of a catalyst. Classes of suitable catalysts include, but are not limited to, tertiary amines, such as triethylamine, and organometallic compounds, such as dibutyltin dilaurate.

Lastly, it is common practice to include abrasion particles in the polilshing pad production process. Exemplary abrading particles include, but are not limited to oxides such as, for example, silicon oxides, aluminum oxides, zirconia, iron oxides, manganese dioxides, and titanium oxides. Additionally, exemplary abrading particles may include, but are not limited to silicon carbides and diamond.

Optionally, it is possible to manufacture urethane polymers for polishing pads with a single mixing step that avoids the use of isocyanate-terminated monomers. As discussed in greater detail above, in accordance with an exemplary embodiment of the present invention, a prepolymer is mixed in an open-air container with the use of a high shear impeller. During the mixing process, atmospheric air is entrained in the mix by the action of the impeller, which pulls air into the vortex created by the rotation. The entrained gas bubbles are thought to act as nucleation sites for the subsequent foaming process. A blowing agent, such as water, is then added to the mix to create the reaction which produces the CO₂ gas responsible for cell growth. During this open-air mix and while in the liquid phase, other optional additives can be added to the mix such as surfactants or additional blowing agents. Finally, the prepolymer is reacted with a foaming agent such as, 4,4′-methylene-bis-o-chloroaniline [MBCA or MOCA]. The MOCA initiates polymerization and cross-linking, causing the viscosity of the mix to increase rapidly. There is a short time window after the addition of MOCA of about 1-2 minutes during which the viscosity of the mix remains low, called the “low-viscosity window.” The mix is poured into the mold during this window. Quickly after the pour, the window passes, and existing pores become effectively frozen in place. Although pore motion has essentially ended, pore growth continues, as CO₂ continues to be produced from the polymerization reaction. The molds then oven cure to complete the polymerization reaction, typically 6-12 hours.

After oven curing, the molds are removed from the oven, allowed to cool, and sliced using a skiver. The slices can be made into circular-shaped pads by cutting them to shape with a punch or cutting tool, after which an adhesive is usually applied to one side of the pad. The pad surface can then be grooved on the polishing surface in a pattern such as a cross-hatched pattern. At that point, the pads are generally ready for use.

Currently, these polishing pads do not result in sufficiently flat wafers immediately after installing the pads on the polishing tool. Instead, the polishing pads are typically “broken-in” after first affixing them to the platens of a polishing tool. A typical break-in process often includes diamond dressing the pads, and running “dummy” wafers in order to improve the stability of the polishing pad performance. Dummy wafers are often processed under the same polishing conditions used for actual production wafers. This ensures that subsequent polished wafers are acceptably flat and uniform.

One problem with the current break-in process is the length of tool time needed to break-in the pad. Logically, the longer a pad takes to break in, the less tool time is spent in actual production of commercial wafer product. A longer break in time also requires the use of more dummy wafers. Both the time lost for production of commercial wafer product and the scrap product in the dummy wafers increase the cost associated with polishing pads. As such, minimization of the break-in time is desirable.

In accordance with one aspect of the present invention, it has been determined that variables which contribute to the break-in of polishing pads include, but are not limited to, changes to pad topography, pad morphology, and the level of pad saturation. For example, in the presence of water and/or chemical slurry, the pad will absorb liquid until saturated. Certain mechanical properties of the pad have been found to change with the amount of water and/or chemical slurry absorbed, and thus stabilize when the pad is fully saturated. Since the time required to achieve saturation is a function of the rate of diffusion of water and/or chemical slurry into the pad, increasing the rate of diffusion of water and/or chemical slurry into the polishing pad is desirable. Thus, in accordance with one aspect of the present invention, a fast break-in polishing pad, which chemically and/or physically facilitates a high rate of absorption of water and/or chemical slurry by the pad, is hereby set forth.

### Physical Pad Configurations

In accordance with an exemplary embodiment of the present invention, a pad is physically configured to have an increased rate of absorption of water and/or chemical slurry into the pad. Stated another way, the pad may be configured to become saturated with water and/or chemical slurry faster, facilitating a faster break-in. In an exemplary embodiment, the fast break-in polishing pad physically increases rate of absorption of water and/or chemical slurry into the pad by decreasing the maximum diffusion distance into the pad.

This embodiment takes advantage of the well-established corollary between diffusion length and time. Not wishing to be bound by theory, Fick's first law of diffusion in one dimension, used in steady state diffusion, i.e., when the concentration within the diffusion volume does not change with respect to time (Jᵢₙ=Jₒᵤₜ), is given by:

$$J = - D \frac{\partial φ}{\partial x} \qquad ( Equation 1 )$$

where J is the diffusion flux, D is the diffusion coefficient or diffusivity, φ is the concentration and x is the position. Since we wish to make a statement about the rate of water and/or chemical slurry absorption, we are interested in the non-steady state case. In this event, the appropriate equation of interest is Fick's 2^{nd} law, which for the one-dimensional case where D is not a function of position, can be written:

$$\frac{\partial φ}{\partial t} = D \frac{{\partial }^{2} φ}{\partial {x}^{2}} \qquad ( Equation 2 )$$

One solution, the case in which a finite quantity α of solute is plated as a thin film on one end of a long rod of solute free material, indicates that as a function of time (t) and position (D), the concentration can be expressed as:

φ=α/(4πDt)^{1/2} exp (−x²/4Dt) (Equation 3)

While this is not exactly the case of water and/or chemical slurry diffusing into a pad, in small concentrations, it indicates a measure which can be used to approximate the amount of diffusion that has taken place. In accordance with Equation 3, an often used rule of thumb says that the distance at which the concentration has fallen to 1/e of its concentration on the surface is given by:

x=2(Dt)^{1/2} (Equation 4)

Thus, it can be seen that for the case of water and/or chemical slurry diffusing into a polishing pad, the time it takes to reach a given concentration is proportional to the square of the distance through which it must diffuse. Thus, in accordance with an exemplary embodiment of the present invention, the maximum distance water and/or chemical slurry must diffuse into a pad is reduced by manipulation of the pad surface including, but not limited to, holes, grooves, or channels, increases pad absorption and reduces saturation and break-in time. More specifically, a reduction in the maximum diffusion distance by half decreases the time required to reach saturation to one fourth.

### i. Hole Spacing And Size

In accordance with an exemplary embodiment of the present invention, the hole(s) can be spaced any distance apart so as to optimize the rate of absorption of water and/or chemical slurry and to reduce pad break-in time. Further, in another exemplary embodiment of the present invention, the spacing of the hole(s) can be any hole spacing, orientation, and/or packing configured to optimize the rate of absorption of water and/or chemical slurry and to reduce pad break-in time. Additionally, in another exemplary embodiment of the present invention, use of one or more holes to optimize the rate of absorption of water and/or chemical slurry and to reduce pad break-in time is disclosed herein. Most preferably, in another exemplary embodiment of the present invention, the fast break-in polishing pad comprises a plurality of holes to reduce the maximum diffusion distance.

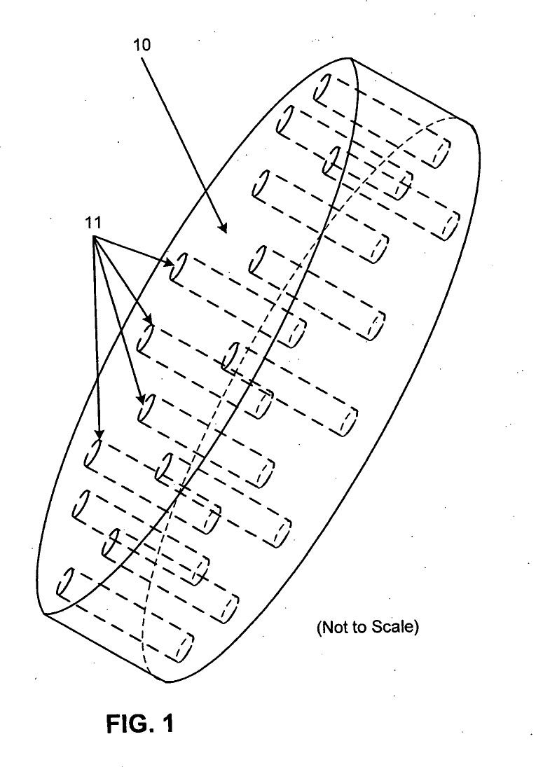

In an exemplary embodiment of the present invention and with reference to FIG. 1, the fast break-in polishing pad 10 comprises a plurality of holes 11. The holes are configured to have a depth associated with each hole. Although the depth can be the same for each hole, it is also anticipated that individual holes can have differing depths. The depth of the hole can be the depth of the pad, such that the holes traverse the entire pad thickness. In accordance with another exemplary embodiment, the holes traverse at least a portion of the pad thickness. For example, the holes can have a depth of one half of the pad thickness. Furthermore, the holes can have any other suitable depth that is configured to decrease the maximum diffusion distance for pad saturation. Moreover, in a further exemplary embodiment, the hole depth is configured to optimize the rate of absorption of water and/or chemical slurry and to reduce pad break-in time.

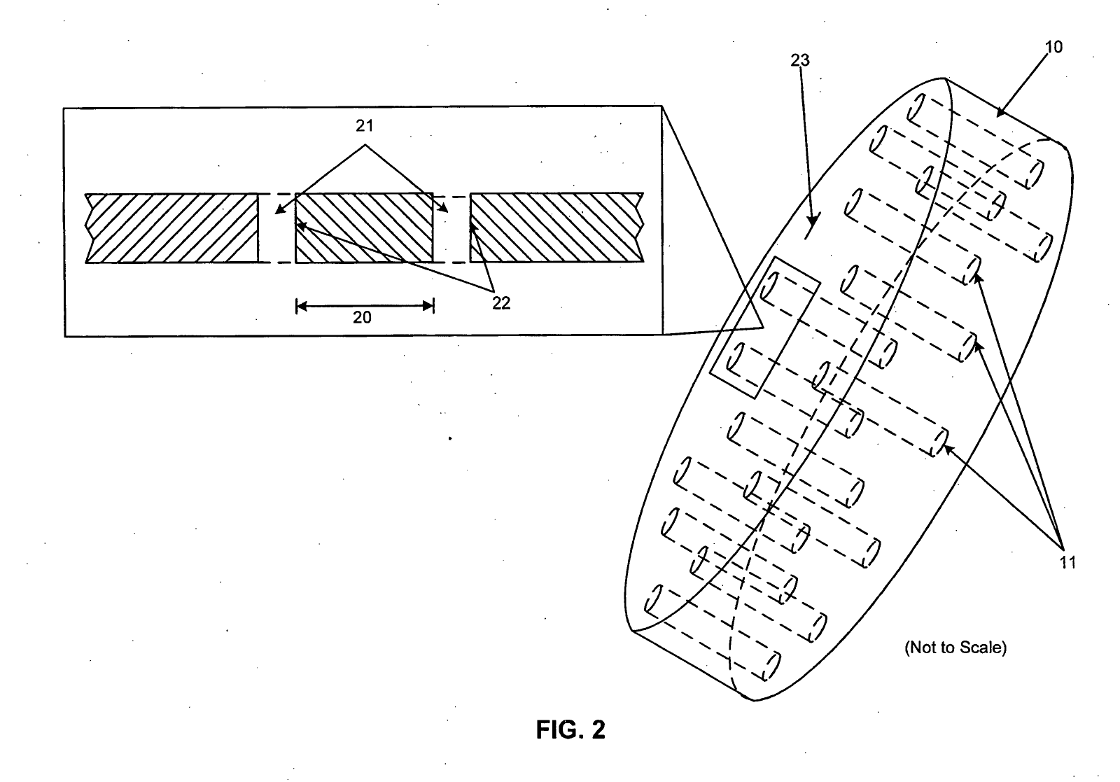

In another exemplary embodiment of the present invention and with reference to FIG. 2, the spacing of the holes may be uniform across the entire pad, or it is also anticipated that spacing can differ across the polishing pad surface 23. In another exemplary embodiment of the present invention, the spacing is configured to be the same between each adjacent hole on the portion of the polishing pad that repetitively communicates with the wafers during polishing, commonly referred to as the “wafer track,” but different across the pad surface that does not communicate with the wafer. In another exemplary embodiment of the present invention, the spacing is configured to be the same between each adjacent hole on any portion of the wafer track, but different across the pad surface that does not communicate with the wafer.

Still with reference to FIG. 2, in another exemplary embodiment of the present invention, the distance 20 between the hole edges 22 are no greater than twice the pad thickness. Stated another way, the edge 22 of one hole 21 is no greater than twice the pad thickness from the edge 22 of an adjacent hole 21. In another exemplary embodiment of the present invention, on a pad of 0.080 inch thickness, the nearest edge-to-edge hole spacing would be no greater than 0.16 inches. In another exemplary embodiment of the present invention, the hole spacing can be any hole spacing configured to optimize the rate of absorption of water and/or chemical slurry and to reduce pad break-in time.

In another exemplary embodiment of the present invention, the holes can be spaced in a hexagonal, a cubic, and a grid packing. One of reasonable skill in the art will recognize that, in addition to the specific embodiments disclosed, numerous hole spacing and packing schemes can be incorporated into the polishing pad to reduce pad break-in time and are contemplated in this disclosure to decrease the maximum diffusion distance, leading to increased pad absorption and reduced saturation and break-in time.

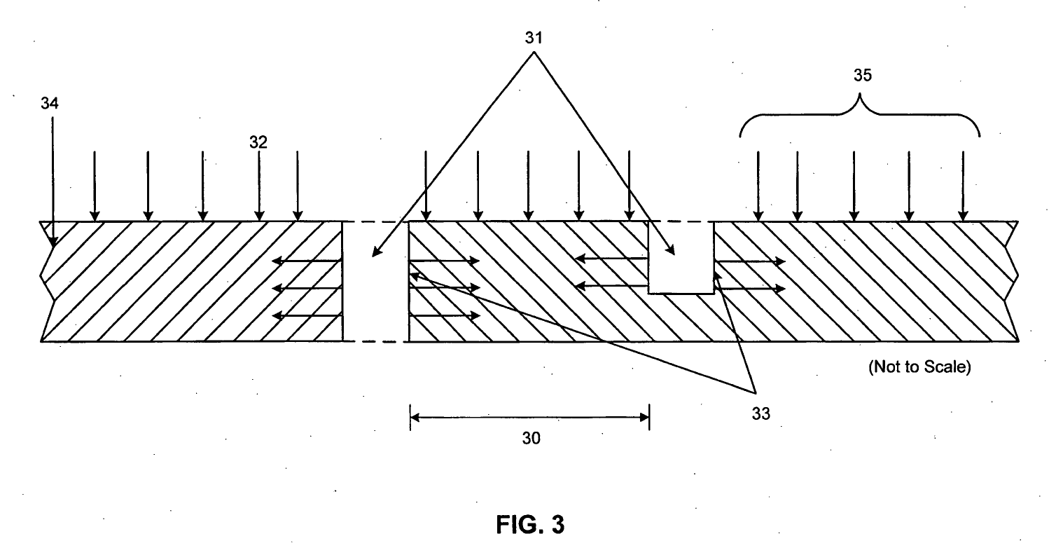

In another exemplary embodiment of the present invention and with reference to FIG. 3, pad 34 with holes 31 with an nearest edge-to-edge distance 30 slightly less than about twice the pad thickness is disclosed. In another exemplary embodiment of the present invention, the water and/or a chemical slurry 32 diffuses vertically from the top surface of the pad 35 at a rate equal to the lateral diffusion of the water along hole edge 33.

The size of the holes is preferably the minimum size needed to achieve wetting of the interior of the hole. In another exemplary embodiment of the present invention, the size of the holes is large enough to overcome water and/or a chemical slurry surface tension and to allow diffusion into the pad. Restated, it is preferable to form holes of a size such that standing water will wet the interior surface of the hole without the assistance of external force, e.g. pressure of the wafer or dummy wafer traversing the pad surface. Moreover, in another exemplary embodiment of the present invention, the hole size (which in one exemplary embodiment is defined in terms of its diameter) is configured to optimize the rate of diffusion of water and/or chemical slurry, thereby increasing pad absorption and reducing saturation and break-in time.

### ii. Hole Shape

In addition to hole size and spacing, hole shape can play a role in the optimization of absorption of water and/or chemical slurry and in reducing pad break-in time. Thus, in another exemplary embodiment of the present invention, the shape or cross-section of holes 21 can be any hole shape or cross-section configured to optimize the rate of absorption of water and/or chemical slurry and to reduce pad break-in time. In another exemplary embodiment of the present invention and with reference to FIG. 2, the shape or cross-section of holes 21 can be circular, wherein each hole comprises a radius (r) and a depth (d). In this exemplary embodiment, the circular hole changes the polishing pad surface area by 2πrd−πr², where 2πrd is the surface area of the cylindrical walls created by the formation of a cylindrical hole and πr² is the circular surface area, which has been removed. Thus, when r is less than 2d, the overall surface area of the pad increases. In another exemplary embodiment of the present invention, increasing surface area optimizes the rate of absorption of water and/or chemical slurry and to reduce pad break-in time, the hole size is r less than 2d, where d is equal to the pad thickness.

In another exemplary embodiment and with reference to FIG. 2, holes 21 can be any cross-sectional shape configured to optimize the rate of absorption of water and/or chemical slurry and to reduce pad break-in time. In another exemplary embodiment of the present invention, the hole edges 22 can form an elliptical, a square, a rectangular, a polygonal, or a random cross-sectional shape. In an exemplary embodiment, the hole configuration increases the rate of absorption of water and/or chemical slurry over the rate the water and/or chemical slurry would have absorbed into the pad without the holes.

In another exemplary embodiment of the present invention, a fast break-in polishing pad comprises at least one groove configured to optimize the rate of absorption of water and/or chemical slurry and to reduce pad break-in time. In an exemplary embodiment, the groove is configured to reduce the diffusion distance. In an exemplary embodiment of the present invention, the groove serves as a channel for the water and/or chemical slurry. Moreover, in another exemplary embodiment of the present invention, as exemplified in the hole embodiment and for the reasons cited above, grooves are spaced apart by a distance of less than two pad thicknesses.

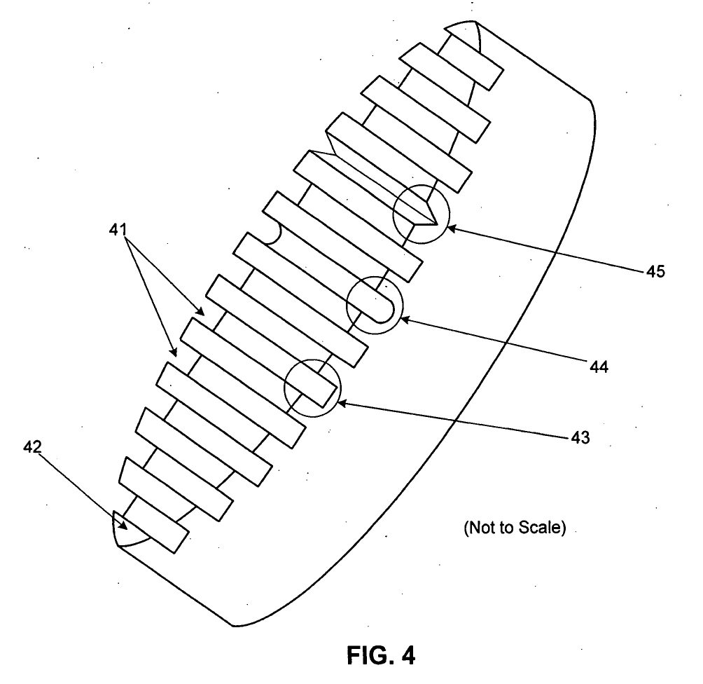

Additionally, in an exemplary embodiment of the present invention, the grooves may be configured to be narrower rather than wider, but at least wide enough to achieve wetting of the interior of the groove. Restated, in another exemplary embodiment of the present invention, the size of the grooves is wide enough to overcome water and/or a chemical slurry surface tension and to allow diffusion into the pad. In another exemplary embodiment of the present invention, the groove traverses the pad thickness at an oblique angle. In an exemplary embodiment of the present invention with reference to FIG. 4, any pattern of grooves configured to optimize the rate of absorption of water and/or chemical slurry and to reduce pad break-in time is contemplated herein. Preferably, as shown in FIG. 4 in an exemplary embodiment of the present invention, the groove pattern comprises grooves 41 running parallel to one another across at least a portion of the polishing pad surface 42. Also, in an exemplary embodiment of the present invention with reference to FIG. 4, the trough geometry or shape of grooves may comprise at least one of a square trough 43, a rounded trough 44, and a triangular trough 45. Moreover, any trough geometry or shape of grooves configured to optimize the rate of absorption of water and/or chemical slurry and to reduce pad break-in time is contemplated herein. In addition to the specific embodiments disclosed, numerous physical configurations of various geometries to the polishing pad surface are contemplated in this disclosure.

In addition to the specific embodiments disclosed, any arrangement, combination, and/or geometry of holes and/or grooves applicable for a single pad would work for a plurality of pads stacked on each other.

In addition to the exemplary pad surface configurations, methods for forming these pads are herein disclosed. In an exemplary embodiment of the present invention, holes and/or grooves can be created via any mechanical method capable of producing holes and/or grooves in a polymer foamed polishing pad. In an exemplary embodiment of the present invention, holes and/or grooves can be created with a punch, a needle, a drill, a laser, an air-jet a water jet, or any other instrument capable of rendering holes or grooves in the pad. Moreover, multiple holes or grooves can be made simultaneously with a multiple-drill bit jig, a multiple punch jig, or a multiple-needle jig.

### Chemical Pad Configurations

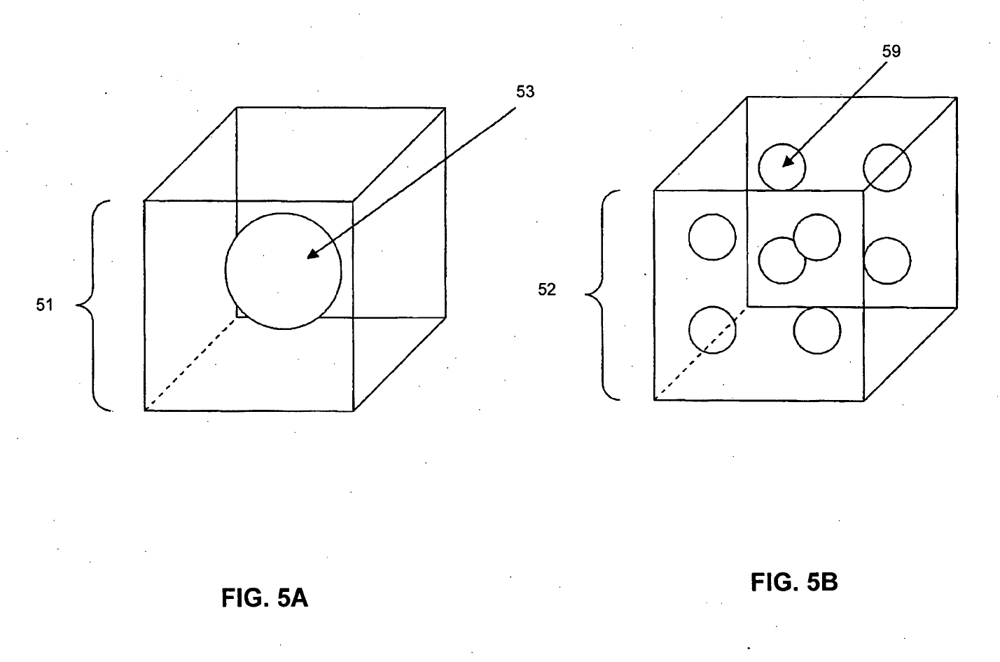

As discussed in more detail below, it is desirable to increase the amount of pores or void spaces in the foamed polishing pad to increase pad absorption and reduce saturation and break-in time. In an exemplary embodiment of the present invention and with reference to FIG. 5, a polishing pad with both one spherical pore or void space 53 per unit cell or with eight spherical pores or void spaces 59 per unit cell is disclosed herein. Moreover, in an exemplary embodiment of the present invention, any amount of pores or void spaces in the foamed polishing pad to increase pad absorption and reduce saturation and break-in time is contemplated herein.

### i. Chemical Foaming Agents

In an exemplary embodiment of the present invention, the polishing pad may be chemically configured to increasing pad absorption and reducing saturation and break-in time. In an exemplary embodiment of the present invention, the polishing pad may be chemically configured to comprise a chemical foaming agent applied to the open-air mix while in the liquid phase, and/or promote increased porosity by discouraging pore combination. Chemical foaming agents discourage the formation of single pores from two or more pores, thereby promoting a pore distribution in the final product of a greater number of smaller pores, thereby reducing the absorption distance of the overall pad. In accordance with another exemplary embodiment, the chemical foaming agent optimizes the rate of absorption of water and/or chemical slurry and to reduce pad break-in time.

In an exemplary embodiment of the present invention, the chemical foaming agent comprises at least one of a hydroflourocarbon (HFC), such as 1,1,1,3,3-pentaflourobutane (HFC-365); 1,1,1,2-tetraflouroethane (HFC-134a), and a free radical initiator comprising an azonitrile, such as 2,4-Dimethyl, 2,2′-Azobis Pentanenitrile. Exemplary foaming agents include the HFCs Solkane® 365mfc and 134a (Solvay, Hannover, Germany), and free radical initiators Vazo 52 (Dupont, Wilmington, Del.). One of reasonable skill in the art will recognize that, in addition to the specific embodiments disclosed, numerous chemical foaming agents can be incorporated into the polishing pad to reduce pad break-in time and are contemplated in this disclosure.

### ii. Cell openers

In an exemplary embodiment of the present invention, the chemical configuration comprises a cell opener which promotes cell opening during the interaction of two cells in the liquid phase. Thus, cell openers can serve to reduce the absorption distance in two ways: 1) through the creation of a plurality of small cells; and 2) by promoting the opening of cell walls to create absorption paths. In accordance with this exemplary embodiment of the present invention, a method for reducing the break-in time for a pad comprises the addition of a cell opener. In this exemplary embodiment of the present invention, the cell opener selected and the amount thereof may be configured to optimize the rate of absorption of water and/or chemical slurry and to reduce pad break-in time.

Exemplary cell openers include, but are not limited to non-hyrdrolizable polydimethylsiloxanes, polyalkyleoxides, dimethylsiloxy, methylpolyethersiloxy, silicone copolymers, wherein the silicone copolymers can be Dabco DC-3043 or Dabco DC-3042 (Air Products, Allentown, Pa.).

### iii. Direct Introduction of Bubbles

In addition to chemical foaming agents and cell openers the absorption distance is reduced, the rate of absorption of water and/or chemical slurry is increased and the pad break-in time is reduced by direct introduction of gas bubbles into the mix, during the mix process. For example, while the mix is still in the liquid state, such as before the addition of MOCA, or after the addition of MOCA but within the low-viscosity window, the output of a gas injector can be inserted directly into the open-air mix, causing the injection of more bubbles than would otherwise be introduced through the action of the impeller alone. Optionally, one could apply micro-filtration to the output end of a pump, such as a gas injector pump, to promote the formation of very small bubbles, such as those in the 1-10 micron diameter range. In accordance with another exemplary embodiment of the present invention, a method of forming a pad includes the step of directly introducing gas bubbles into the air-mix in the liquid phase. This step of directly introducing gas bubbles may involve the selection of the size and quantity of bubbles, which may be configured to optimize the rate of absorption of water and/or chemical slurry and to reduce pad break-in time.

The detailed description of exemplary embodiments of the invention herein shows various exemplary embodiments and the best modes, known to the inventors at this time, of the invention are disclosed. These exemplary embodiment and modes are described in sufficient detail to enable those skilled in the art to practice the invention and are not intended to limit the scope, applicability, or configuration of the invention in any way. Rather, the following disclosure is intended to teach both the implementation of the exemplary embodiments and modes and any equivalent modes or embodiments that are known or obvious to those of reasonably skill in the art. Additionally, all included figures are non-limiting illustrations of the exemplary embodiments and modes, which similarly avail themselves to any equivalent modes or embodiments that are known or obvious to those of reasonable skill in the art.

Other combinations and/or modifications of structures, arrangements, applications, proportions, elements, materials, or components used in the practice of the instant invention, in addition to those not specifically recited, can be varied or otherwise particularly adapted to specific environments, manufacturing specifications, design parameters, or other operating requirements without departing from the scope of the instant invention and are intended to be included in this disclosure.

Unless specifically noted, it is the Applicant's intent that the words and phrases in the specification and the claims be given the commonly accepted generic meaning or an ordinary and accustomed meaning used by those of ordinary skill in the applicable arts. In the instance where these meanings differ, the words and phrases in the specification and the claims should be given the broadest possible, generic meaning. The words and phrases in the specification and the claims should be given the broadest possible meaning. If any other special meaning is intended for any word or phrase, the specification will clearly state and define the special meaning.

What is claimed is:

1. A polishing pad configured to optimize the rate of absorption and to reduce break-in time comprising:
a foamed polishing pad, wherein said foamed polishing pad comprises both a surface and a thickness; and
a plurality of holes in at least a portion of said foamed polishing pad surface, wherein the nearest edge of each pair of adjacent holes in said plurality of holes is spaced apart by no greater than twice said foamed polishing pad thickness.

2. The polishing pad of claim 1, wherein said plurality of holes are uniformly spaced across at least a portion of said foamed polishing pad surface.

3. The polishing pad of claim 1, wherein said plurality of holes comprises at least one hole with at least one of a circular, an elliptical, an oval, a square, a rectangular, and a polygonal cross-section.

4. The polishing pad of claim 3, wherein said at least one hole has a circular cross-section and wherein said at least one circular hole comprises a radius of less than twice said foamed polishing pad thickness.

5. The polishing pad of claim 1, wherein said plurality of holes are greater than the minimum size needed to achieve wetting of the interior of said hole.

6. The polishing pad of claim 1, wherein said foamed polishing pad comprises at least one of a urethane foam, a ethylene foam, a styrene foam, a vinyl chloride foam, and an acryl foam.

7. The polishing pad of claim 1, wherein at least a portion of said plurality of holes are uniformly distributed throughout said foamed polishing pad surface.

8. The polishing pad of claim 7, wherein said uniformly distributed holes are configured in at least one of a hexagonal, a cubic, and a grid packing configuration.

9. The polishing pad of claim 1, wherein at least a portion of said plurality of holes extend through the entire thickness of said foamed polishing pad.

10. The polishing pad of claim 1, wherein at least a portion of said plurality of holes comprises holes of varying size and depth.

11. The polishing pad of claim 1, wherein said at least a portion of said foamed polishing pad surface is the wafer track.

12. A polishing pad to optimize the rate of absorption and to reduce break-in time comprising:
a foamed polishing pad, wherein said foamed polishing pad comprises both a surface and a thickness; and
a plurality of grooves in at least a portion of said foamed polishing pad surface, wherein the edge of each pair adjacent grooves in said plurality of grooves is spaced apart by no greater than twice said foamed polishing pad thickness.

13. The polishing pad of claim 12, wherein said plurality of grooves are uniformly spaced across at least a portion of said foamed polishing pad surface.

14. The polishing pad of claim 12, wherein said plurality of grooves comprises at least one groove perpendicular to at least one other groove.

15. The polishing pad of claim 12, wherein said plurality of grooves comprises at least one curved groove.

16. The polishing pad of claim 12, wherein at least a portion of said plurality of grooves comprises grooves of varying size and depth.

17. The polishing pad of claim 12, wherein said at least a portion of said foamed polishing pad surface is the wafer track.

18. A method of producing a polishing pad to optimize the rate of absorption and to reduce break-in time of the final foamed polishing pad comprising:
preparing a prepolymer solution;
mixing said prepolymer solution in an open-air mix, wherein at least one of a gas bubble and a blowing agent are added to said open-air mix;
optionally, adding at least one of a chemical foaming agent, wherein said chemical foaming agent allows for formation of a plurality of small pores in the foam, and a cell opener, wherein said cell opener allows for formation of a plurality of small cells in the foam, to said prepolymer solution;
optionally, adding at least one abrading particle to said prepolymer solution;
adding a polymerizing agent;
allowing the mixture to foam;
optionally, creating at least one of a hole and a groove with a mechanical device;
forming a foamed polishing pad out of said foam.

19. The method of claim 18, wherein said polymerizing agent comprises an isocyanate-terminated monomer.

20. The method of claim 18, wherein said mechanical device comprises at least one of a punch, a needle, a drill, a laser, an air-jet a water jet, a multiple-drill bit jig, a multiple punch jig, and a multiple-needle jig.
